(19) United States
(12) Patent Application Publication
(10) Pub. No.: US 2002/0046370 A1
(43) Pub. Date: Apr. 18, 2002

(54) Error checking

(76) Inventor: Rodrigo Cordero, Eastville (GB)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/931,574

(22) Filed: Aug. 16, 2001

(30) Foreign Application Priority Data
Aug. 18, 2000 (GB) 0020444.6

(51) Int. Cl. H04B 1/74

(52) U.S. Cl. 714/48

(57) ABSTRACT

Error checking circuitry for performing error checks based on mathematical functions comprises a data input stage adapted to receive incoming data and at least one feedback signal, a register arranged to receive at a plurality of register input signals from the data input stage and to generate at least one signal to feedback to the data input stage, and multiplexing circuitry, wherein the multiplexing circuitry is provided in association with the register such that signal routes through the register are configurable to successively perform error checks based on different first and second mathematical functions.

### This invention relates to error checking and in particular to apparatus and methods for effecting a cyclic redundancy check on data.

It is known to carry out cyclic redundancy checks on data in many communication protocols and data storage formats. Such checks are a way of detecting small changes in blocks of data and increase the reliability of data transmissions and storage techniques.

A block of data may be regarded as a single large numerical value. A CRC algorithm divides this large value by a polynomial (referred to hereinafter as the generator polynomial) to leave a remainder that may be appended to the data in the form of a checksum before it is sent or written. When the data is received or recovered from storage the CRC algorithm is reapplied and the result compared with the appended checksum. Errors in the data can be indicated by a difference between the new result and the appended checksum. The mathematics of polynomial division is based on Galois field (modulo 2) algebra and appropriate selection of the generator polynomial can detect almost 99.999% of errors.

Many different CRC generator polynomials are used in order to establish different error detection properties. Commonly used examples include “16-bit” generator polynomials such as G(x)=x¹⁶+x¹²+x⁵+1=0 and “32-bit” generator polynomials such as G (x)=x³²+x²⁶+x²³+x²²+x¹⁶+x¹²+x¹¹+x¹⁰+x⁸+x⁷+x⁵+x⁴+x²+x+1=0. CRC error checking techniques only detect errors in data and do not correct the errors. However, the data receiving or recovery step can be repeated until the data is free of errors. Systems which only detect errors (ARQ systems) are used when data accuracy is not critical and the data can be retransmitted, for example in internet and teletext applications. CRC error checking is used in, for example, file transmission protocols in which generator polynomials maybe used to detect data transmission errors typically caused by transmission line noise. If the receiver detects an error it sends a “negative acknowledge” symbol to the transmitter responsive to which the data is retransmitted. Alternatively, the receiver may ignore the data containing the error and instead wait for refreshed data.

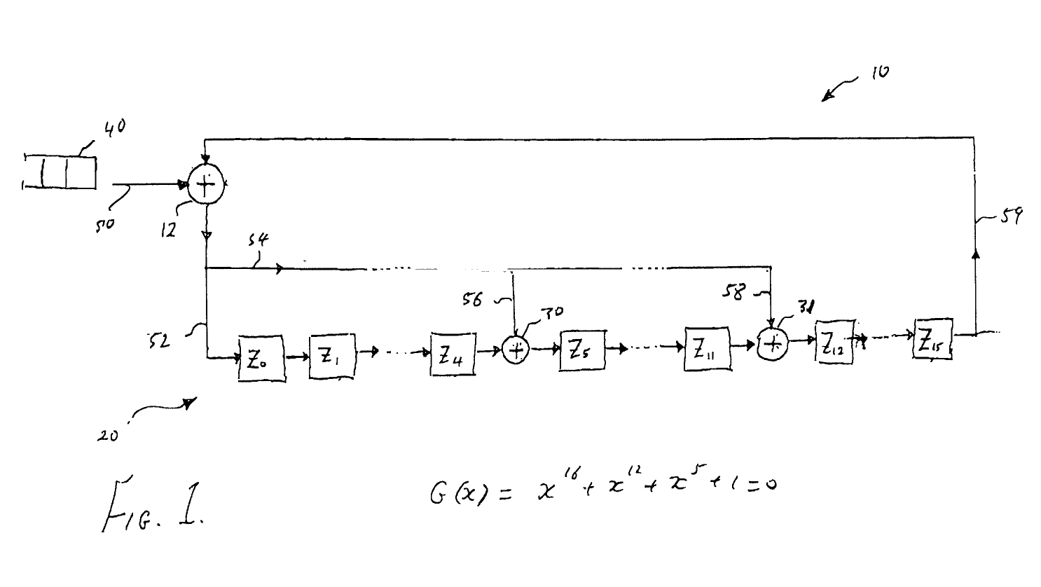

A known type of CRC calculator implemented in hardware is shown in FIG. 1. The CRC calculator 10 comprises a data input stage 12 and a polynomial division register 20 of a length corresponding to the remainder produced by the polynomial to be used. In this example, the calculator divides the data to be checked by the 16-bit generator polynomial mentioned hereinabove. The register 20 comprises a series of elementary delay elements Z₀ to Z₁₅ (not all of which are shown), the first of which comprises a first register input stage, and further register input stages 30,31 in the form of XOR-gates. The positions of the further register input stages 30,31 are selected to implement the terms of the chosen generator polynomial. The delay elements Z₀ to Z₁₅ are implemented as clocked flip-flops and each can hold a single bit.

In use, the register 20 is initialised for example by loading all of the delay elements Z₀ to Z₁₅ with values of one or zero. The incoming bit stream 40 to be checked is shifted in from the left on line 50 and into the register 20 via line 52 bit-by-bit. A polynomial division (modulo 2) is similar to common binary division, a difference being that we perform a logical exclusive—OR operation instead of a binary subtraction. The feedback line 59 connects the output of the register 20 with the data input stage 12 such that each data bit is compared with the most significant bit in the register 20 and only if the bits differ will the polynomial be subtracted.

As the data is shifted in the full remainder is maintained within the register and can thus be compared with the appended checksum to establish whether or not an error has occurred.

A problem with the above type of error checking circuitry is that it can only apply CRC algorithms based on a single predetermined generator polynomial because the number and configuration of the components is fixed during manufacture. If it is required to apply two or more different generator polynomials in succession a further CRC calculator or at least a further polynomial division register must be provided in hardware.

The present invention seeks to provide improved error checking circuitry and methods for checking errors in data.

According to a first aspect of the present invention there is provided Error checking circuitry for performing error checks based on mathematical functions comprising: a data input stage having a data node adapted to receive incoming data to be checked and a plurality of input feedback nodes; a register having a plurality of data input nodes each data input node being selectable to receive data from the data input stage and a set of output feedback nodes arranged to selectively supply a feedback signal to the data input stage; and multiplexing circuitry provided in association with the register and the data input stage to selectively connect one of said output feedback nodes to the data input stage and to selectively connect said data node to at least some of said data input nodes such that the signal routes through the error checking circuitry are configurable to successively perform error checks based on different mathematical functions.

Preferably, the register comprises a plurality of delay elements, each capable of holding one bit. Such a register comprises a first data input node and a plurality of further data input nodes disposed between selected ones of the delay elements.

Preferably, the multiplexing circuitry is arranged to selectively connect an incoming data signal from the input stage and a zero signal to said further data input nodes of the register. In preferred embodiments, the multiplexing circuitry selects between two or more signals from the input stage to determine signals to be input into one or more of said further register input stages.

Preferred registers comprise a plurality of feedback outputs and the multiplexing circuitry selects between two or more of the feedback outputs to determine a signal to be input to the register.

In preferred embodiments, the multiplexing circuitry comprises combinatorial logic for combining the incoming data with a feedback signal from said register. Said combinatorial logic may comprise two XOR-gates and two multiplexing stages, each receiving inputs from said combinatorial logic stages. The same function select signal can be applied to both multiplexing stages.

In one embodiment, the register comprises delay elements in the form of flip-flops in sufficient numbers to implement error checking on a 32-bit CRC generator polynomial and the incoming data comprises a digital video data stream. The register comprises further register input stages disposed to implement error checking based on 32-bit and 16-bit CRC polynomials, some of which further register input stages being used in error checks based on both 32-bit and 16-bit generator polynomials.

According to a second aspect of the present invention there is provided a method of checking an incoming bit stream for errors, comprising the steps of: receiving at an input stage an incoming bit stream; supplying a plurality of input signals from said input stage to a register arranged to receive the plurality of input signals at a plurality of data input nodes, each data input node being selectable to receive said plurality of input signals, and to generate a plurality of feedback signals; connecting one of said feedback signals to the input stage to perform an error check based on a first mathematical function; and subsequently disconnecting said feedback signal and connecting another one of said feedback signals to the input stage thereby to perform an error check based on a second, different, mathematical function.

Thus embodiments of the invention enable the performance of error checking based on different mathematical functions using shared hardware resources. For example, CRC error checks based on different generator polynomials can be performed successively on different portions of an incoming bit stream. The overall number of components required to implement the error checking is reduced considerably and thus error checking circuitry embodying the present invention is easier and cheaper to manufacture.

Embodiments of the present invention will now be described by way of example only with reference to the accompanying drawings in which:

FIG. 1 illustrates a known CRC calculator implemented in hardware;

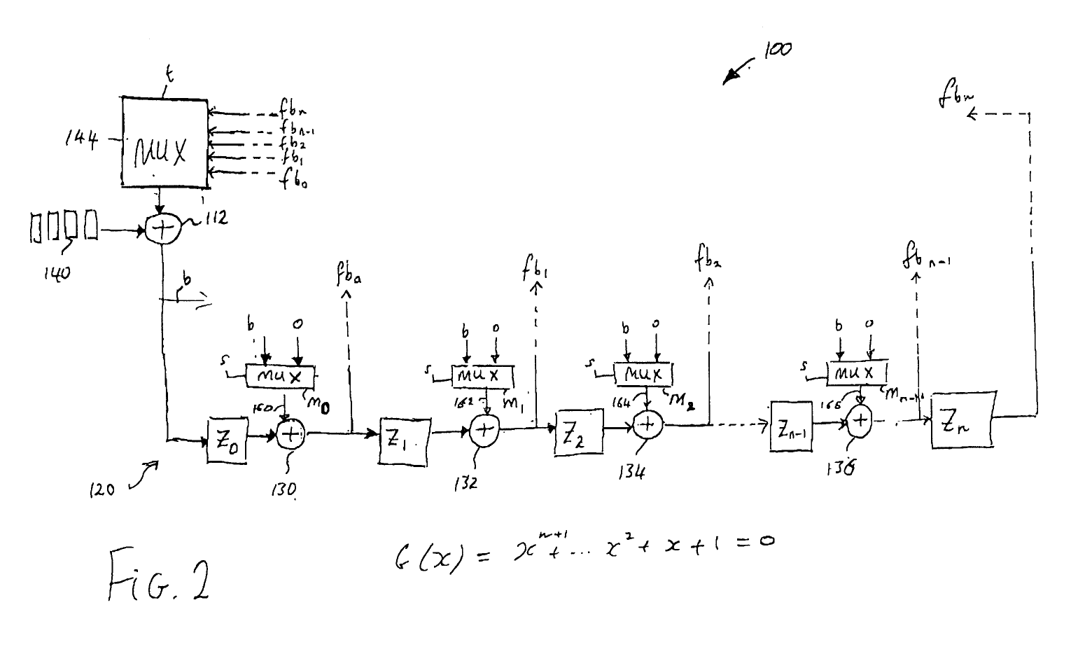

FIG. 2 illustrates a general implementation of error checking circuitry embodying the present invention;

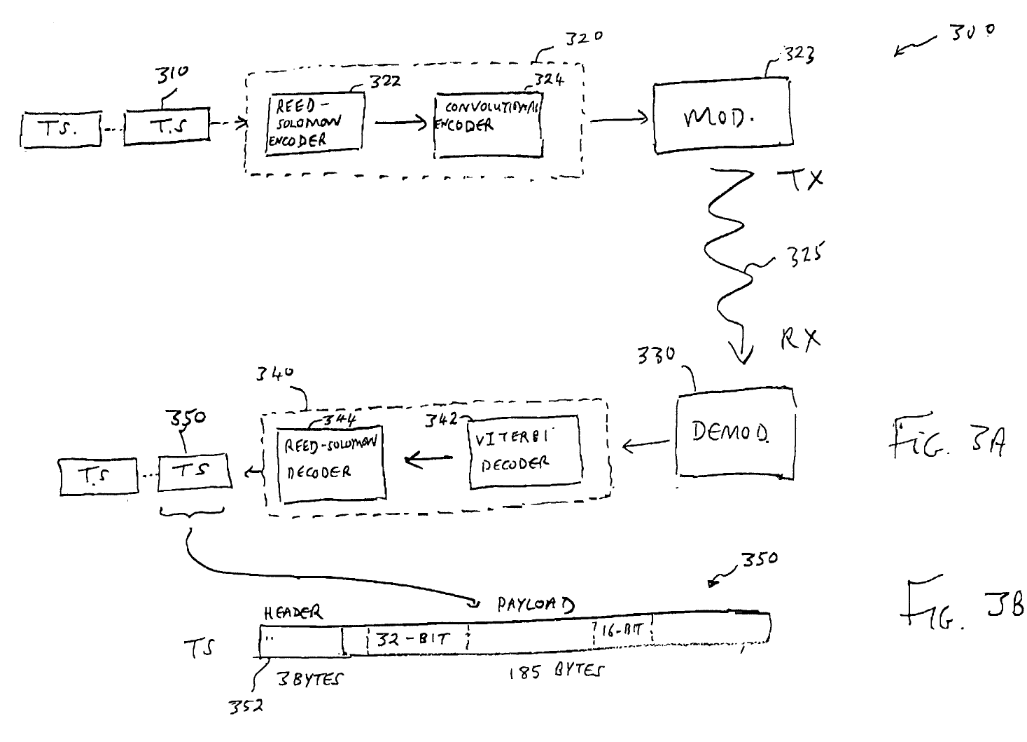

FIG. 3A illustrates a digital TV transmission and reception process;

FIG. 3B illustrates a transport packet stream according to a digital TV standard; and

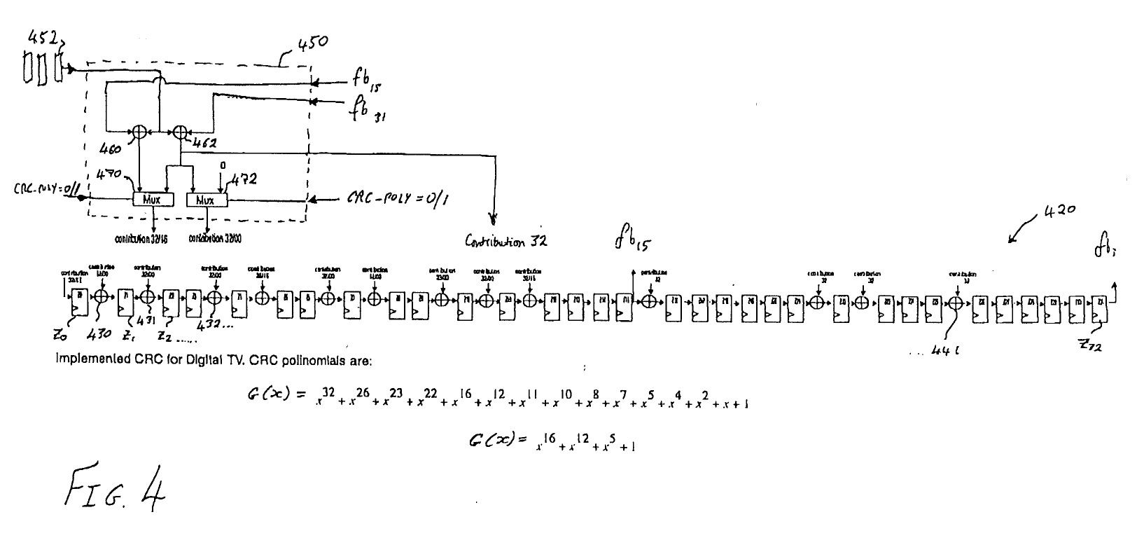

FIG. 4 illustrates a second implementation of error checking circuitry embodying the present invention.

FIG. 2 illustrates error checking circuitry in which interconnections between the hardware components making up the error checking circuitry are configurable to enable selection between two or more error checking polynomials. In this way, error checking algorithms employing different generator polynomials can be applied to data successively using the same circuitry.

Referring to FIG. 2, the error checking circuitry 100 comprises an input stage 112 and a polynomial division register 120. The input stage 112 which comprises combinatorial logic in the form of an XOR-gate is connected to a data supply line 140 and a feedback multiplexor 144. The function of the feedback multiplexor 144 will be explained below. The polynomial division register 120 has a length corresponding to the remainder produced by the largest generator polynomial to be used. In this example, the polynomial is assumed to be of the nth degree with polynomial terms having powers of between 0 and n. Such a polynomial may be represented mathematically as follows: G(x)=xⁿ+. . . x²+x+1=0. The polynomial need not include terms with x to the power of all values been 0 and n. The polynomial division register 120 includes a series of delay elements Z₀ to Zₙ each comprising a clocked flip-flop capable of holding one bit value. The first delay element Z₀ is supplied with an input signal from the input stage 112. The polynomial division register 120 comprises further register input stages 130 to 136 disposed between selected delay elements Z₀ to Zₙ . In this general embodiment, there is a single further register input stage disposed between each of said delay elements Z₀ to Zₙ. The further register input stages 130 to 136 are connected to register input multiplexors M₀ to Mₙ₋₁, from which the register input stages 130 to 136 receive input supplied on lines 160, 162 to 166. The register input multiplexors M₀ to Mₙ₋₁ are each supplied with an input signal b, zero signal 0 and a multiplexor select signal S. The input signal b is output from the input stage 112 and corresponds to the signal shifted into the first delay element Z₀.

The polynomial division register 120 also comprises a number of feedback lines F_{b0} to F_{bn} . There is one feedback line F_{b0} ,F_{bn}on the downstream side of each delay element Z₀ to Zₙ. All of the feedback lines F_{b0} to F_{bn} are supplied to the feedback multiplexor 144 which also receives a feedback selection signal t.

The error checking circuitry of FIG. 2 can be configured to implement any polynomial with a remainder length in bits not exceeding the length of the polynomial division register 120. This can be achieved by selecting between the various inputs b, 0 and feedbacks F_{b0} to F_{bn} using the multiplexor select signals s and t respectively. The error checking circuitry of FIG. 2 can be dynamically reconfigured to implement different polynomials successively as may be required. Where appropriate the error checking circuitry of FIG. 2 can apply different generator polynomials to the same data stream.

In use, the register 120 is initialised and the data to be checked 140 is shifted in from left to right. The division operation as performed by the register 120 is similar to that performed by the prior art circuit described with reference to FIG. 1 and will not be described in detail here.

Assume that the error checking circuitry of FIG. 2 comprises a register 120 in which the delay elements are numbered from 0 to n, where n=31. In order to implement the 16-bit polynomial, the register input multiplexors m₄ and m₁₁ are selected to supply the signal b to their associated further register input stages and the feedback multiplexer 144 selects the signal fb₁₅ over the other feedback signal lines. All other further register input multiplexors pass zero signals such that their associated delay stages act transparently. With the error checking circuitry configured as described the remainder of the circuitry is temporarily redundant. In this way, the configurable circuitry of FIG. 2 implements the 16-bit generator polynomial as described in relation to the error checking circuit 10 of FIG. 1.

The error checking circuitry of FIG. 2 can also be used to implement polynomials having different mathematical terms, for example the 32-bit polynomial mentioned hereinbefore. In this case, the further register input multiplexors m₀, m₁, m₃, m₄, m₆, m₇, m₉, m₁₀, m₁₁, m₁₅, m₂₁, m₂₂and m₂₅ are selected to pass signal b and the signal on line fb₃₁ is selected by the feedback multiplexor 144 over and above the other feedback signals. As before the further register input multiplexors which are not selecting signal b pass a zero signal such that the associated delay elements have no effect. Thus, in this way the error checking circuitry of FIG. 2 can also deliver the functionality of the 32-bit algorithm.

The error checking circuitry of FIG. 2 can be dynamically reconfigured to deliver the functionality of any error checking polynomial having a remainder length not exceeding the length of the register 120. Further, the error checking circuitry shares hardware resources in order to perform divisions based on multiple polynomials. There are many different CRC error checking polynomials and all of these can be implemented by error checking circuitry embodying the present invention. Longer generator polynomials provide a greater assurance of data accuracy and are fully useable over larger amounts of data. However, shorter polynomials are preferred in certain applications since they have shorter reminder values and thus require less error checking overheads.

Where the intended application is known in advance of manufacture, error checking circuitry embodying the present invention may be further simplified. For example if the generator polynomials to be used can be identified in advance, it may be possible to reduce the number of components further by leaving out any unnecessary delay components and simplifying the multiplexing circuitry. By way of example a further embodiment is disclosed here in relation to FIGS. 3 and 4. This embodiment is designed specifically with digital TV applications in mind and thus comprises only as many components as required to perform error checking of the code employed in the MPEG-2 digital TV standard.

FIG. 3 illustrates how transport packets according to the MPEG-2 standard can be encoded and decoded in digital TV transmission systems 300. Transport packets 300 each of length 188 bytes are input to a forward error correction (FEC) encoder 320 comprising a Reed-Solomon encoder 322 and a convolutional encoder 324. The Reed-Solomon encoder 322 appends a 16-byte long Reed-Solomon code to the end of each transport packet 310. This code can be used to correct up to 8 bytes of errored bytes per transport packet 310 as will be understood by a skilled person. The convolutional encoder 324 is then used to bring the BER down further by application of known convolutional codes. The encoded stream is then passed to a modulation stage 323 (e.g. an 8PSK modulator) and thereafter is transmitted over the interface as indicated by reference numeral 325.

At the receiving end the modulated encoded stream is fed to a demodulator 330 where it is demodulated. The encoded stream is supplied to a forward error correction system 340 which comprises a viterbi decoder 342 and a Reed-Solomon decoder 344, in which error checking and forward error correction is applied to yield the transport packets 350.

FIG. 3B illustrates a transport stream packet 350 in more detail. The transport stream packet 350 includes a 3-byte long header portion 352 and a payload portion which is 185 bytes in length. The payload portion can be partitioned in many ways however, it generally includes a type of section requiring 32-bit CRC error checking and PES (packet elementary stream) packets which require 16-bit CRC error checking.

FIG. 4 illustrates a further example of error correction circuitry embodying the present invention. The error correction circuitry of FIG. 4 is designed to perform CRC error checking of transport stream packets 350 after they are output from the forward error control system 340 based on both the 32-bit and the 16-bit error checking polynomials mentioned hereinbefore. Each of these polynomials will be applied successively as the serial bit stream to be checked is supplied to the circuitry in series. It can also be assumed that no other polynomials will need to be implemented. Since the 32-bit and 16-bit CRC polynomials to be used have some common terms and other polynomial configurations need not be considered, the minimum number of circuitry components can be identified and only these need be provided in hardware.

Referring to FIG. 4, the error checking circuitry has a polynomial division register 420 of length sufficient to contain the remainder after division by the 32-bit generator polynomial. The polynomial division register 420 thus comprises 32 clocked flip-flops Z₀ to Z₃₁ arranged in series. The left most flip-flop acts as a first register input stage and the polynomial division register 420 comprises further register input stages 431 to 441 disposed between selected ones of the flip-flops. As before these further register input stages 430 to 441 comprise XOR-gates. However in this case, the XOR-gates are provided only at register input stages 430 to 441 corresponding to the implementation of the 16-bit and 32-bit generator polynomials. That is, the XOR-gates are provided only between the following flip-flop pairs Z₀-Z₁, Z₁-Z₂, Z₃-Z₄, Z₄-Z₅, Z₆-Z₇, Z₇-Z₈, Z₉-Z₁₀, Z₁₀-Z₁₁, Z₁₁-Z₁₂, Z₁₅-Z₁₆, Z₂₁-Z₂₂, Z₂₂-Z₂₃ and Z₂₅-Z₂₆. The register input stages applying to both the 16-bit and 32-bit generator polynomials are indicated on FIG. 4 by the reference 32/16, whereas the register input stages applying to the 32-bit polynomial only are indicated by reference numerals 32/00 (if input within the range Z₀ to Z₁₅) and 32 (if input within the range Z₁₅ to Z₃₁). Feedback lines need only be taken off at positions in the register corresponding to the end of the 16-bit and 32-bit polynomials, namely after delay elements Z₁₅ and Z₃₁. These feedback lines are indicated on FIG. 4 by reference numerals fb₁₅ and fb₃₁, respectively. Additional register input stages and feedback lines are not provided.

Still referring to FIG. 4, the feedback multiplexing and register input multiplexing functions described in relation to FIG. 2 are managed by a single multiplexing block 450. The multiplexing block 450 receives as inputs the data to be checked 452, first and second polynomial select signals CRC_POLY=0/1 and 16-bit and 32-bit feedback signals fb₁₅, fb31. The multiplexing block 450 generates as outputs the register input contributions designated 32/16, 32/00 and 32. The register inputs 32/16 are used to implement both the 16-bit and the 32-bit generator polynomials, whereas the register inputs 32/00 and 32 are used only to implement the 32-bit generator polynomial. Internally, block 450 comprises first and second XOR-gates 460,462 and first and second multiplexors 470,472. The first XOR-gate 460 receives the data to be checked 452 and the feedback signal fb₁₅. The first XOR-gate 460 has its output connected to a first input of the multiplexor 470. The second XOR-gate 462 receives the data to be checked 452 and the feedback signal fb₃₁. The output of the second XOR-gate 462 is supplied as a second input to the first multiplexor 470, as a first input to the second multiplexor 472 and to the register 420 directly as register input contribution 32. The multiplexor 472 receives a zero signal as its second input. The multiplexors 470 and 472 also receive a multiplexor select signal CRC_POLY=0/1.

When the CRC—POLY=0/1 signal is not asserted, the first multiplexor 470 generates the XOR combination of the data stream 452 and the feedback signal fb₁₅ at its output. This output is supplied to each of the 16-bit register input stages 32/16. At the same time, the second multiplexor 472 supplies a zero output to each of the 32-bit only register input stages 32/00, 32, making each of the associated delay elements redundant. Thus, with the CRC—POLY=0/1 signal not asserted the error checking circuitry implements the 16-bit generator polynomial using selected components from those available. The remainder of the circuitry is temporarily redundant.

When the CRC—POLY=0/1 1 signal is asserted, the first multiplexor 470 outputs the XOR combination of the incoming data 452 and the feedback signal fb₃₁. This output is supplied to the 32/16-bit register input stages in the form of signal 32/16. At the same time, the second multiplexor 472 outputs the same XOR combination to the 32-bit register input stages in the form of signal 32/00. The separate register input signal 32 also corresponds to the XOR combination of the incoming data and the feedback signal fb₃₁. This signal is applied to the remaining 32-bit register input stages as contribution 32. In this configuration, the error checking circuitry of FIG. 4 fully implements the 32-bit generator polynomial and can perform error checking based thereon.

Thus, the preferred embodiments of the present invention use shared hardware resources to apply different error checking algorithms successively to different portions of an incoming data stream. If the generator polynomials employed in the error checking algorithm can be identified in advance, the circuitry can be simplified to further reduce the number of hardware components required.

Implementations of the invention should not be limited to the configurations of the described embodiments. Specifically, the described embodiments are examples of configurations which may be used to implement preferred methods and are not intended to define the only apparatus features/method steps which can be used. For example, a skilled person will be aware that if the CRC result is attached to the end of the data, the receiving CRC register can be arranged to clear itself automatically if there is no error. That is, each bit of the stored or transmitted CRC value should cancel the similar bit in the CRC register. If all of the bits are not cancelled the data contains an error and must be retransmitted or recovered again.

1. Error checking circuitry for performing error checks based on mathematical functions comprising:
a data input stage having a data node adapted to receive incoming data to be checked and a plurality of input feedback nodes;
a register having a plurality of data input nodes each data input node being selectable to receive data from the data input stage and a set of output feedback nodes arranged to selectively supply a feedback signal to the data input stage; and
multiplexing circuitry provided in association with the register and the data input stage to selectively connect one of said output feedback nodes to the data input stage and to selectively connect said data node to at least some of said data input nodes such that the signal routes through the error checking circuitry are configurable to successively perform error checks based on different mathematical functions.

2. Error checking circuitry according to claim 1, wherein the register comprises a plurality of delay elements, each capable of holding one bit.

3. Error checking circuitry according to claim 2, wherein the register comprises a first data input node and a plurality of further data input nodes disposed between selected ones of the delay elements.

4. Error checking circuitry according to claim 3, wherein the multiplexing circuitry is arranged to selectively connect an incoming data signal from the input stage and a zero signal to said data input nodes of the register.

5. Error checking circuitry according to any preceding claim, wherein the multiplexing circuitry comprises combinatorial logic for combining the incoming data with a feedback signal from said register.

6. Error checking circuitry according to claim 5, wherein said multiplexing circuitry includes two combinatorial logic stages each comprising an XOR-gate.

7. Error checking circuitry according to claim 6, wherein the multiplexing circuitry includes two multiplexing stages each receiving an input from said combinatorial logic stages.

8. Error checking circuitry according to claim 7, wherein a multiplexor select signal indicating the mathematical function to be used is supplied to both said multiplexing stages.

9. Error checking circuitry according to any preceding claim, wherein the register comprises a number of delay elements sufficient to implement error checking based on a 32-bit CRC generator polynomial.

10. Error checking circuitry according to any preceding claim, wherein the incoming data comprises a digital video data stream.

11. Error checking circuitry according to any of claims 3 to 10, wherein certain ones of said further data input nodes are, in use employed in error checks based on both said 32-bit and 16-bit CRC generator polynomials.

12. A method of checking an incoming bit stream for errors, comprising the steps of:
receiving at an input stage an incoming bit stream;
supplying a plurality of input signals from said input stage to a register arranged to receive the plurality of input signals at a plurality of data input nodes, each data input node being selectable to receive said plurality of input signals, and to generate a plurality of feedback signals;
connecting one of said feedback signals to the input stage to perform an error check based on a first mathematical function; and
subsequently disconnecting said feedback signal and connecting another one of said feedback signals to the input stage thereby to perform an error check based on a second, different, mathematical function.

13. Error checking circuitry substantially as described herein with reference to FIG. 3.

14. Error checking circuitry substantially as described herein with reference to FIG. 4.
